(19) United States
(12) Patent Application Publication
(10) Pub. No.: US 2022/0126555 A1
(43) Pub. Date: Apr. 28, 2022

(54) LAMINATING DEVICE, LAMINATING METHOD AND DISPLAY DEVICE

(71) Applicant: YUNGU (GU'AN) TECHNOLOGY CO., LTD., Langfang (CN)

(72) Inventors: Chunxiao GU, Langfang (CN); Shuai Zhang, Langfang (CN); Shuo Yang, Langfang (CN)

(73) Assignee: YUNGU (GU'AN) TECHNOLOGY CO., LTD., Langfang (CN)

(21) Appl. No.: 17/572,269

(22) Filed: Jan. 10, 2022

(30) Foreign Application Priority Data
Apr. 20, 2021 (CN) 202110423461.X

(51) Int. Cl. B32B 37/10; B32B 37/00; B32B 37/16

(52) U.S. Cl. CPC B32B 37/10; B32B 2457/20; B32B 37/16; B32B 37/0046

(57) ABSTRACT

The present disclosure discloses a laminating device, a laminating method, and a display device. The laminating device is configured to laminate a flexible member to be laminated to a curved receiving member. The laminating device includes a gasbag. The gasbag includes an elastic housing configured for receiving gas medium. The elastic housing includes a carrying portion and a clamping portion which are connected to each other. The carrying portion is configured to carry the flexible member to be laminated. The elastic housing is provided with a plurality of first apertures. When a gas pressure in the elastic housing reaches a first preset pressure, the gas medium is released to outside of the elastic housing through the first apertures. This design can avoid a bad laminating caused by an improper adjustment of laminating pressure.

### CROSS-REFERENCE TO RELATED APPLICATION

This application claims priority to Chinese Patent Application No. 202110423461.X, filed on Apr. 20, 2021, entitled “LAMINATING DEVICE, LAMINATING METHOD AND DISPLAY DEVICE”, the content of which is hereby incorporated by reference in its entirety.

### TECHNICAL FIELD

The present disclosure relates to the field of display technology.

### BACKGROUND

An Organic Light Emitting Diode (OLED) screen has good flexibility and is widely used in curved display devices. Moreover, with the development of technology, display devices develop from a display device having two curved surfaces to a display device having a plurality of curved surfaces, for example, a display device having four curved surfaces. In addition, the curved radian of the curved surface of a display device has gradually increased, and the curved surface of the display device having a large radian, and disposed in an inverted form, have become a new trend.

### SUMMARY

According to various embodiments, a laminating device, a laminating method, and a display device are provided to solve the problem of different pressure adjustments in the process of laminating.

In a first aspect, the present disclosure provides a laminating device configured to laminate a flexible member to be laminated to a curved receiving member. The laminating device includes a gasbag. The gasbag includes an elastic housing configured for receiving a gas medium.

The elastic housing includes a carrying portion and a clamping portion which are connected to each other. The carrying portion is configured to carry the flexible member to be laminated.

The elastic housing is provided with a plurality of first apertures. When a gas pressure in the elastic housing reaches a first preset pressure, the gas medium is released to the outside of the elastic housing through the first apertures.

In one of the first aspects, the first apertures are located in the clamping portion.

In one of the first aspects, the elastic housing includes a first housing and a second housing. The first housing is located on a peripheral side of the second housing.

The elastic housing includes a first receiving cavity and a second receiving cavity. The first receiving cavity is enclosed by the first housing and the second housing, and the second receiving cavity is defined by the second housing.

The first housing includes a first clamping portion and the first apertures. The clamping portion includes the first clamping portion, the first apertures are located in the first clamping portion.

The second housing includes at least one second aperture. When a gas pressure in the second housing reaches a second preset pressure, the gas medium in second housing is released to the first receiving cavity through the at least one second aperture. The second preset pressure is less than the first preset pressure.

In one of the first aspects, the elastic housing further includes a third housing. The third housing is located between the first housing and the second housing and the third housing surrounds the second housing.

The first receiving cavity includes a first sub-cavity and a second sub-cavity. The first sub-cavity is enclosed by the first housing and the third housing.

The third housing includes at least one third aperture. When a gas pressure in the third housing reaches a third preset pressure, the gas medium in the third housing is released to the first sub-cavity through the at least one third aperture. The third preset pressure is between the first preset pressure and the second preset pressure.

In one of the first aspects, the second housing includes a second clamping portion corresponding to the first clamping portion, and the third housing includes a third clamping portion corresponding to the first clamping portion. The first clamping portion, the second clamping portion and the third clamping portion are assembled together and arranged side by side. An end surface of the first clamping portion, an end surface of the second clamping portion and an end surface of the third clamping portion are located on a same plane.

In one of the first aspects, the laminating device further includes a gas pressure controlling mechanism in communication with the second receiving cavity. The gas pressure controlling mechanism includes a gas inlet channel configured for controlling the gas pressure in the elastic housing.

In one of the first aspects, the first preset pressure is in a range of 300 Kgf to 350 Kgf. The third preset pressure is in a range of 200 Kgf to 250 Kgf. The second preset pressure is in a range of 100 Kgf to 200 Kgf.

In one of the first aspects, a hardness of the carrying portion is less than a hardness of the clamping portion.

In one of the first aspects, the carrying portion includes a body portion and a corner portion which are connected to each other. The corner portion is located between the body portion and the clamping portion. A hardness of the corner portion is less than a hardness of the body portion.

In a second aspect, the present disclosure provides a laminating method. The laminating method includes:

S10, providing a flexible member to be laminated, a curved receiving member and the laminating device according to any one of the first aspects;

S20, filling the elastic housing with a first filling amount of gas medium, wherein the gas pressure in the elastic housing is less than the first preset pressure;

S30, bringing the flexible member to be laminated to the carrying portion of the elastic housing to form a primary laminated assembly;

S40, contacting the primary laminated assembly with the curved receiving member; and

S50, filling the elastic housing with the gas medium until the gas pressure in the elastic housing reaches the first preset pressure, wherein the elastic housing presses against the flexible member to be laminated during a process of filling the gas medium.

In one of the second aspects, the curved receiving member includes a flat receiving portion and a curved receiving portion. The S50 includes:

filling the elastic housing with the gas medium, wherein the elastic housing presses against the flexible member to be laminated; the flexible member to be laminated and the curved receiving member are laminated along a direction from the flat receiving portion to the curved receiving portion, such that the flexible member to be laminated and the curved receiving member are gradually laminated together.

In a third aspect, the present disclosure provides a display device. The display device is manufactured by using the laminating device according to any one of the first aspects, or manufactured by using the laminating method according to any one of the second aspects.

It is to be appreciated that since the elastic housing is provided with the first apertures, when the gas pressure in the elastic housing reaches the first preset pressure, the gas medium in the elastic housing can be released to the outside of the elastic housing through the first apertures of the elastic housing. That is, the first apertures of the elastic housing of the gasbag can be used to automatically adjust the laminating pressure between the flexible member to be laminated and a curved receiving member, and the maximum laminating pressure can be controlled within a preset range to avoid a poor laminating caused by an inaccurate detection and adjustment of the laminating pressure. In addition, due to the first apertures of the elastic housing of the gasbag, the elastic housing can always remain the preset gas pressure therein through a release of the gas medium, thus remaining a preset laminating pressure between the flexible member to be laminated and a curved receiving member, which further ensures the laminating yield.

### BRIEF DESCRIPTION OF THE DRAWINGS

In order to illustrate the embodiments of the present disclosure more clearly, the drawings used in the embodiments will be described briefly. The following described drawings are merely for the embodiments of the present disclosure, and other drawings can be derived by those of ordinary skill in the art without any creative effort.

FIG. 1a is a schematic view of a gasbag of a laminating device according to a first embodiment of the present disclosure;

FIG. 1b is a schematic view of the gasbag corresponding to the embodiment of the FIG. 1a when carrying a flexible screen;

FIG. 2 is a schematic view of a laminating device according to a second embodiment of the present disclosure;

FIG. 3 is a schematic view of a laminating device according to a third embodiment of the present disclosure;

FIG. 4 is a schematic view of a laminating device according to a fourth embodiment of the present disclosure;

FIG. 5 is a schematic view of a laminating device according to a fifth embodiment of the present disclosure;

FIG. 6 is a flowchart of a laminating method according to an embodiment of the present disclosure; and

FIG. 7 is a schematic view showing a state before laminating in a laminating method according to an embodiment of the present disclosure.

### REFERENCE NUMERALS ILLUSTRATION

100—gasbag, 110—elastic housing, 120—receiving cavity, 111—first housing, 1101—first aperture, 121—first receiving cavity, 112—second housing, 1102—second aperture, 122—second receiving cavity, 113—third housing, 1211—first sub-cavity, 1212—second sub-cavity, 114—carrying portion, 1141—body portion, 1142—corner portion, 115—clamping portion, 1151—first clamping portion, 1152—second clamping portion, 1153—third clamping portion, 200—flexible screen, 300—curved cover plate, 301—flat portion, 302—curved portion, 400—gas pressure controlling mechanism, 410—gas inlet channel, 420—gas outlet channel, 500—guiding film.

### DETAILED DESCRIPTION

The technical solutions in the embodiments of the present disclosure will be clearly and completely described below in conjunction with the drawings in the embodiments of the present disclosure. The described embodiments are only a part of the embodiments of the present disclosure, rather than all the embodiments. Based on the embodiments in this disclosure, all other embodiments obtained by a person of ordinary skill in the art without creative work shall fall within the protection scope of this disclosure.

During the process of laminating a flexible screen to a curved cover plate, in order to form a display device having a curved surface, the laminating pressure is often difficult to adjust accurately, thus resulting in poor laminating and affecting production efficiency.

As mentioned in the background, in the laminating process, especially in the curved laminating process in which the flexible screen is laminated to the curved cover plate, it is necessary to provide a suitable laminating pressure to avoid bubbles from being generated due to insufficient laminating pressure, or avoid damages caused by excessive laminating pressure. A technology for accurately controlling the laminating pressure is lacking in the prior art. Even if the laminating process may be improved by pressure adjustment, the process is complicated and the control accuracy is not high, and poor laminating is likely to occur.

The present disclosure provides a laminating device used for laminating a flexible member to be laminated to a curved receiving member. The laminating device includes a gasbag. The gasbag includes an elastic housing configured for receiving a gas medium. The elastic housing includes a carrying portion 114 and a clamping portion 115 which are connected to each other. The carrying portion 114 is used to carry the flexible member to be laminated. The elastic housing is provided with a plurality of first apertures. When a gas pressure in the elastic housing 110 reaches a first preset pressure, the gas medium is released to the outside of the elastic housing though the first apertures. By providing the first apertures in the elastic housing of the gasbag, and when the gas pressure in the elastic housing 110 reaches the first preset pressure, the first apertures are in an open state so that the gas medium in the elastic housing can be released to the outside of the elastic housing through the first apertures. The gas medium is further transferred into the elastic housing 110, and due to the first apertures, a further increase in the laminating pressure can be avoided. As such, the laminating pressure can be monitored and adjusted automatically, the complexity of the laminating device is reduced, and damage caused by excessive laminating pressure is avoided.

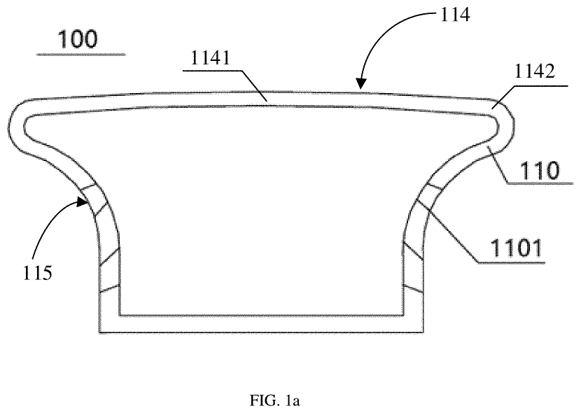

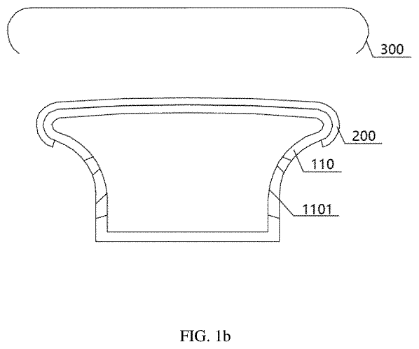

The laminating device according to the present disclosure is used for laminating the flexible member to be laminated to the curved receiving member. Take a flexible screen and a curved cover plate as an example, the curved cover plate can be a curved cover plate with two curved surfaces, a curved cover plate with four curved surfaces, etc., which is not limited in the present disclosure. The embodiments of the present disclosure take the laminating of the flexible screen and the curved cover plate as an example for illustration. The specific implementations of present disclosure will be described in detail below with reference to FIGS. 1 to 7.

FIG. 1a is a schematic view of a gasbag of a laminating device according to a first embodiment of the present disclosure, and FIG. 1b is a schematic view of a gasbag corresponding to the embodiment of the FIG. 1a when carrying a flexible screen. Referring to FIGS. 1a and 1b, a laminating device includes a gasbag 100. During a laminating process, the gasbag 100 is used to carry a flexible screen 200 to be laminated, and the gasbag 100 is also used to laminate a flexible screen 200 to be laminated to a curved cover plate 300.

The gasbag 100 includes an elastic housing 110 used for receiving a gas medium.

It can be understood that when the laminating pressure or a shape of the gasbag 100 needs to be adjusted during the laminating process, the adjustment in the laminating pressure during the laminating process can be achieved mainly by adjusting the filling amount of gas medium in the elastic housing 110. In a non-laminating process, the elastic housing 110 may not contain the gas medium, thereby facilitating storage, handling, and transportation. Of course, the elastic housing 110 can also always contain a fixed filling amount of a gas medium. For example, during a plurality of laminating processes of the same specification, a certain filling amount of the gas medium can be retained after each laminating process is completed, which is convenient for beginning the next laminating process, thereby improving the laminating efficiency. This disclosure does not limit whether there is always a gas medium in the elastic housing 110, as long as the elastic housing 110 can receive the gas medium and can be expanded under a function of the gas medium, which can meet the requirement of the laminating of the flexible screen 200 and the curved cover plate 300.

The elastic housing 110 includes a carrying portion 114 and a clamping portion 115 which are connected to each other. The carrying portion 114 is used to carry the flexible screen 200. Accordingly, the carrying portion 114 can be understood as a portion of the elastic housing 110 corresponding to the flexible screen 200 when the flexible screen 200 is carried, or in other words, an area of the carrying portion can be understood as an area designed according to a size of the flexible screen 200 to be laminated. The clamping portion 115 and the carrying portion 114 are connected to each other. In this embodiment, the carrying portion 114 of the elastic housing 110 realizes the carrying function of the gasbag 100 to the flexible screen 200. The elastic housing 110 is used to receive the gas medium. The elastic housing 110 can be deformed under the function of the gas medium, so as to realize the full laminating of the flexible screen 200 and the curved cover plate 300.

The elastic housing 110 is provided with a plurality of first apertures 1101 thereon. When the gas pressure in the elastic housing 110 reaches a first preset pressure, the gas medium is released to the outside of the elastic housing 110 through the first apertures 1101. In other words, each of the first apertures 1101 has a closed state and an open state. When the gas pressure in the elastic housing 110 does not reach the preset pressure, the first apertures 1101 remain closed, and the elastic housing 110 of the gasbag 100 provides the corresponding laminating pressure during the laminating process according to the amount of gas medium contained therein. As the amount of the gas medium in the elastic housing 110 increases, the gas pressure in the elastic housing 110 increases, and when the gas pressure is applied in the laminating process of the flexible screen 200 and the curved cover plate 300, the laminating pressure applied on the flexible screen 200 increases. When the gas pressure in the elastic housing 110 reaches the first preset pressure, the first apertures 1101 are in an open state so that the gas medium in the elastic housing 110 is released to the outside of the elastic housing 110 through the first apertures 1101 to avoid a continued increase in the laminating pressure. Therefore, the first preset pressure can be set as the gas pressure in the elastic housing 110 corresponding to the maximum pressure required for the laminating of the flexible screen 200 and the curved cover plate 300 according to requirements. Specifically, the appropriate first preset pressure can be obtained through simulation tests or a plurality of verifications, and there is no need to accurately monitor the filling amount of the gas medium, the laminating pressure can be within the expected range through the first apertures 1101.

Further, the first apertures 1101 are located in the clamping portion 115. Since the clamping portion 115 does not need to carry the flexible screen 200, it is more convenient for the release of the gas medium to the outside of the elastic housing 110 when the gas pressure in the elastic housing 110 is reaching the first preset pressure.

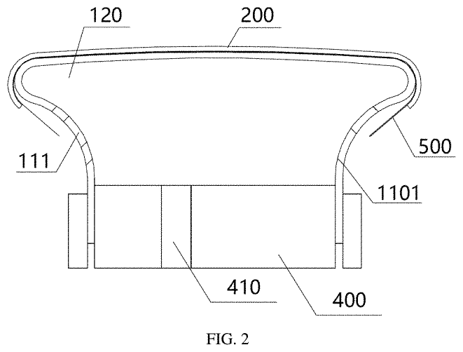

FIG. 2 is a schematic view of a laminating device according to a second embodiment of the present disclosure. Referring to FIG. 2, the gasbag 100 includes an elastic housing 110, and the elastic housing 110 defines a receiving cavity 120, the elastic housing 110 forms a space for receiving gas medium. It can be understood that in order to facilitate the adjustment during the laminating process, the elastic housing 110 needs to be filled with the gas medium and needs to release the gas medium. Specifically, the laminating device further includes a gas pressure controlling mechanism 400. The gas pressure controlling mechanism 400 is in communication with the receiving cavity 120. Therefore, during the laminating process, the elastic housing 110, the gas pressure controlling mechanism 400 and the like cooperate together to define the space for receiving the gas medium, but this does not affect the receiving function of the elastic housing 110 to the gas medium. The elastic housing 110 is used for receiving the gas medium, and the present disclosure is not limited to that the elastic housing 110 independently achieves the function of receiving the gas medium. The gas pressure controlling mechanism 400 includes at least a gas inlet channel 410 for realizing an input of the gas medium. The gas pressure controlling mechanism 400 may further include a gas outlet channel for realizing an output of the gas medium after the laminating process is completed. Of course, the gas inlet channel 410 can also have a function of the gas outlet channel, that is, the gas inlet channel 410 is used to input the gas medium to the elastic housing 110 or release the gas medium in the elastic housing 110 to the outside of the elastic housing 110 at different times.

In the prior art, when the flexible screen is laminated to the curved cover plate, in order to facilitate the control of the laminating process and the maintenance of relatively fixed relationship between the flexible screen and a laminating pressure head, the flexible screen can be firstly disposed on a guiding film to form a combined body before the laminating. Then, the combined body is disposed on a carrying surface of the laminating pressure head by supporting and dragging of the guiding film, so as to laminate the curved cover plate and the flexible screen. In the present disclosure, taking the flexible screen 200 being dragged by the guiding film 500 as an example for illustration, the flexible screen 200 is dragged by the guiding film 500 and then conformally disposed on the carrying portion 114 of the elastic housing 110. A size of the guiding film 500 is larger than a size of the flexible screen 200. The exceeding portion of the guiding film 500 is used to adjust a position of the flexible screen during the laminating process through the dragging mechanisms such as clamping jaws, so as to avoid the poor laminating caused by an advance contact between the curved cover plate and the flexible screen. Referring to FIG. 2, in this embodiment, the gas pressure controlling mechanism 400 is clamped at an end of elastic housing 110 of the gasbag 100 away from the carrying portion 114. The gas pressure controlling mechanism 400 is used to control the gas pressure in elastic housing 110 of the gasbag 100 during the laminating process. That is, the gas pressure controlling mechanism 400 adjusts the amount of the gas medium in elastic housing 100 of the gasbag 100 through the gas inlet channel 410 and can define the shape of elastic housing 110 of the gasbag 100. The elastic housing 110 defines the receiving cavity 120 and forms a relatively closed space together with the gas pressure controlling mechanism 400, the gas pressure controlling mechanism 400 adjusts and controls the laminating pressure. Further, in this embodiment, the clamping portion 115 includes a supporting portion and a fixing portion. The supporting portion is located between the carrying portion 114 and the fixing portion. The fixing portion is used to be fixed with the gas pressure controlling mechanism 400. In this case, in order to facilitate the release of the gas medium through the first apertures 1101, the first apertures 1101 can be disposed in the supporting portion, thereby facilitating the adjustment of the gas pressure in the elastic housing 110 of the gasbag 100.

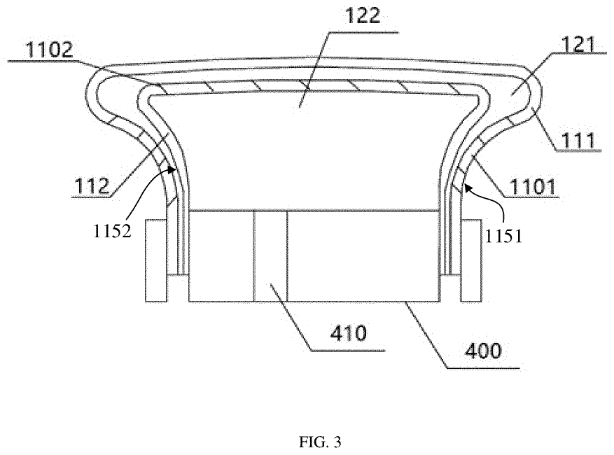

FIG. 3 is a schematic view of a laminating device according to a third embodiment of the present disclosure. Referring to FIG. 3, the elastic housing 110 includes a first housing 111 and a second housing 112. The first housing 111 is located on a peripheral side of the second housing 112. The elastic housing 110 includes a first receiving cavity 121 enclosed by the first housing 111 and the second housing 112. The elastic housing 110 further includes a second receiving cavity 122 defined by the second housing 112. The first housing 111 includes a first clamping portion 1151 and a plurality of first apertures 1101. The clamping portion 115 includes the first clamping portion 1151. The first apertures 1101 are located in the first clamping portion 1151. The second housing 112 includes at least one second aperture 1102. When the gas pressure in the second housing 112 reaches a second preset pressure, the gas medium is released to the first receiving cavity 121 through the at least one second aperture 1102. The second preset pressure is less than the first preset pressure.

In other words, the elastic housing 110 may include a plurality of housings. As shown in FIG. 3, the elastic housing 110 includes the first housing 111 and the second housing 112. The outer housing (the first housing 111) surrounds the inner housing (the second housing 112). The elastic housing 110 includes a plurality of receiving cavities defined by the plurality of housings, and each housing includes a plurality of apertures of different sizes. The apertures can be opened when subjected to corresponding gas pressure, so as to release the gas medium to the outside of this housing. The gas pressure required for opening the apertures on the inner housing is less than the gas pressure required for opening the apertures on the outer housing, so that the apertures on the outermost housing can be opened when subjected to the maximum gas pressure corresponding to the maximum laminating pressure, thereby accurately monitoring the laminating pressure and avoiding excessive laminating pressure.

In addition, due to the plurality of housings, the gas pressure required to open the apertures of the plurality of housings along a direction from the inside of the elastic housing 110 to the outside of elastic housing 110 gradually increases. When the gas medium is filled, the plurality of housings expand one by one, the laminating pressure provided by the gasbag in this case is more uniform than the laminating pressure provided by the gasbag in a case that the gasbag includes a single housing, thereby improving the uniformity of the laminating pressure.

The first housing 111 is located on the peripheral side of the second housing 112, the first housing 111 includes the first clamping portion 1151 and the first apertures 1101, and the clamping portion 115 includes the first clamping portion 1151. In other words, the first housing 111 is the outermost housing of the elastic housing 110 of the gasbag 100, and the gas medium in the elastic housing 110 of the gasbag 100 is released to the outside of the elastic housing 110 through the first apertures 1101. The first apertures 1101 are located in the first clamping portion 1151, which facilitates the release of the gas medium. The second housing 112 includes the at least one second aperture 1102, and the at least one second aperture 1102 can be located in any area of the second housing 112 surrounded by the first housing 111, so that the gas medium is released from the second receiving cavity 122 to the first receiving cavity 121. When the gas pressure in the second housing 112 reaches the second preset pressure, the gas medium is released from the second receiving cavity 122 to the first receiving cavity 121 through the at least one second aperture 1102. The gas medium in the second receiving cavity 122 continues to be increased, and the gas pressure in the second receiving cavity 122 is maintained to be greater than the second preset pressure, the gas medium is released to the first receiving cavity 121 through the at least one second aperture 1102. The gas pressure in the first receiving cavity 121 reaches the first preset pressure, the first apertures 1101 are opened, and the gas medium in the first receiving cavity 121 is released to the outside of the elastic housing 110 through the first apertures 1101.

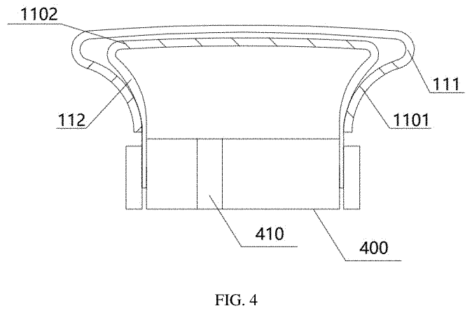

The first housing 111 being located on the peripheral side of the second housing 112 means that the first housing 111 may entirely surround the peripheral side of the second housing 112, or the first housing 111 may partially surround the peripheral side of the second housing 112. FIG. 4 is a schematic view of a laminating device according to a fourth embodiment of the present disclosure. Referring to FIG. 4, the elastic housing 110 includes the first housing 111 and the second housing 112, the first housing 111 includes a first carrying portion and a first clamping portion 1151 which are connected to each other, the second housing 112 includes a second carrying portion and a second clamping portion 1152 which are connected to each other, when the first housing 111 partially surrounds the peripheral side of the second housing 112, an end surface of the first clamping portion 1151 of the first housing 111 away from the first carrying portion is closer to the first carrying portion compared with an end surface of the second clamping portion 1152 of the second housing 112 away from the second carrying portion. When the first housing 111 partially surrounds the peripheral side of the second housing 112, in order to facilitate the realization of laminating, the first housing 111 surrounds the peripheral side of the carrying portion of the second housing 112 and at least part of the clamping portion of the second housing 112. It can be understood that since the first housing 111 is the outermost housing of the elastic housing 110 of the gasbag 100, the first carrying portion is the carrying portion of the elastic housing 110. The clamping portion 115 includes the first clamping portion 1151, so that the gas medium in the elastic housing 110 is released to the outside of the elastic housing 110 through the first apertures 1101 more conveniently.

The second housing 112 includes a second carrying portion and a second clamping portion 1152. When the second housing 112 is partially surrounded by the first housing 111, the second carrying portion is inevitably entirely surrounded by the first housing 111 located at the outer side of the second housing 112, and the second clamping portion 1152 may be partially surrounded by the first clamping portion 1151. That is, the first clamping portion 1151 and the second clamping portion 1152 not surrounded by the first clamping portion 1151 jointly form the clamping portion 115 of the elastic housing 110.

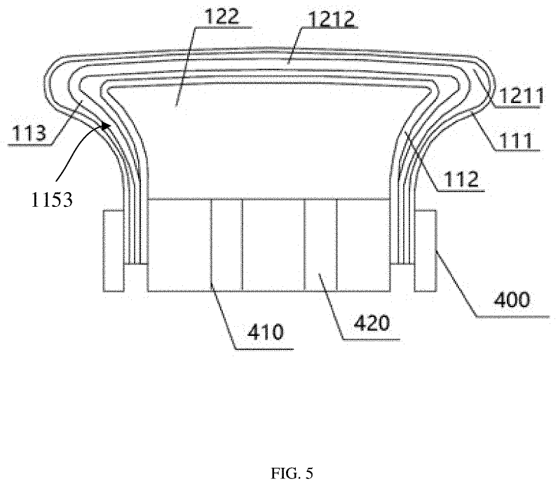

FIG. 5 is a schematic view of a laminating device according to a fifth embodiment of the present disclosure. Referring to FIG. 5, the elastic housing further includes a third housing 113. The third housing 113 is located between the first housing 111 and the second housing 112, and the third housing 113 surrounds the second housing 112. The first receiving cavity 121 includes a first sub-cavity 1211 and a second sub-cavity 1212. The first sub-cavity 1211 is enclosed by the first housing 111 and the third housing 113, the second sub-cavity 1212 is enclosed by the second housing 112 and the third housing 113. The third housing 113 includes at least one third aperture (the aperture of each housing is not shown in the figure). When the gas pressure in the third housing 113 reaches a third preset pressure, the gas medium is released to the first sub-cavity 1211 through the at least one third aperture. The third preset pressure is between the first preset pressure and the second preset pressure.

Specifically, the first preset pressure is in a range of 300 Kgf to 350 Kgf; the third preset pressure is in a range of 200 Kgf to 250 Kgf; and the second preset pressure is in a range of 100 Kgf to 200 Kgf. Correspondingly, in the open state, a size of the first aperture 1101 is in a range of 5 μm to 10 μm, a size of the third aperture is in a range of 10 μm to 20 μm, and a size of the second aperture is in a range of 15 μm to 30 μm.

When the elastic housing 110 includes a plurality of housings, the size of the first aperture of the first housing is preferably in a range of 5 μm-10 μm. That is, the size of the aperture on the outermost housing is in a range of 5 μm-10 μm. When the elastic housing 110 includes N housings, which are first, second, . . . , Nth housing in a direction from the outside of the elastic housing 110 to the inside of the elastic housing 110, and the size of the aperture on the Nth housing is (5-10)*N μm.

In this embodiment, the second housing 112 includes the second clamping portion 1152 corresponding to the first clamping portion 1151, and the third housing 113 includes a third clamping portion 1153 corresponding to the first clamping portion 1151. The first clamping portion 1151, the second clamping portion 1152 and the third clamping portion 1153 are assembled together and arranged side by side. An end surface of the first clamping portion 1151 away from the first carrying portion, an end surface of the second clamping portion 1152 away from the second carrying portion and an end surface of the third clamping portion 1153 away from the third carrying portion are located on the same plane. In other words, the first clamping portion 1151 entirely surrounds the outside of the second clamping portion 1152, and the second clamping portion 1152 entirely surrounds the outside of the third clamping portion 1153, which facilitates the manufacture of the gasbag and the adjustment of the laminating pressure during the laminating process.

When the elastic housing 110 includes a plurality of housings, the innermost housing may be connected to the gas inlet channel 410 of the gas pressure controlling mechanism 400. For example, as shown in FIG. 5, the gas inlet channel 410 of the gas pressure controlling mechanism 400 is in communication with the second receiving cavity 122, which facilitates the filling of the gas medium. The gas pressure controlling mechanism 400 may include the gas inlet channel 410 and the gas outlet channel 420, to control the amount of the gas medium in the elastic housing 110 of the gasbag 100 and adjust the gas pressure in the elastic housing 110 of the gasbag 100. In other embodiments, the gas pressure controlling mechanism 400 may also include a plurality of gas transmission channels corresponding to a plurality of receiving cavities respectively, which is convenient for filling or releasing gas medium.

The elastic housing 110 includes the carrying portion 114 and the clamping portion 115. In an embodiment, a hardness of the carrying portion 114 is less than a hardness of the clamping portion 115. Compared with the carrying portion 114, the clamping portion 115 has a greater hardness to support the carrying portion 114 and ensure the shape of the carrying portion 114.

Preferably, the carrying portion 114 includes a body portion 1141 and a corner portion 1142 which are connected to each other. The corner portion 1142 is located between the body portion 1141 and the clamping portion 115. A hardness of the corner portion 1142 is less than a hardness of the body portion 1141. The corner portion 1142 are at least used to realize the laminating between the flexible screen 200 and the curved portion of the curved cover plate 300. It can be understood that in order to avoid the generation of bubbles during the laminating, when the laminating is started, the elastic housing 110 of the gasbag 100 firstly presses the flexible screen 200 to make the flexible screen 200 and a flat portion of the curved cover plate 300 contact with each other, and then laminated together. When the flexible screen 200 is in contact with the curved cover plate 300, the gasbag 100 or the flexible screen 200 does not contact a curved portion of the curved cover plate 300. Therefore, since a distance between the corner portion 1142 of the carrying portion 114 of the elastic housing 110 and the curved portion of the curved cover plate 300 is larger than a distance between the body portion 1141 of the carrying portion 114 of elastic housing 110 and the flat portion of the curved cover plate 300, by setting the hardness of the corner portion 1142 of the carrying portion 114 of the elastic housing 110 to be less than the hardness of the body portion 1141 of the carrying portion 114 of the elastic housing 110, the corner portion 1142 is more easily deformed at the same pressure, which can reduce the difference in laminating pressure caused by the difference in distance, and which can ensure the uniformity of pressure.

Further, the hardness of the clamping portion 115 is in a range of 50 degrees to 60 degrees in Shore, to support the entire carrying portion 114. The hardness of the body portion 1141 is in a range of 30 degrees to 40 degrees in Shore. The hardness of the corner portion 1142 is in a range of 20 degrees to 30 degrees in Shore. The elastic housing 110 may be made of rubber materials such as silicone, nylon or polyurethane.

When the elastic housing includes a plurality of housings, each housing may adopt the above-mentioned design, or only the outermost housing (for example, the first housing 111) may adopt the above-mentioned hardness design.

In an embodiment, a curvature of the elastic housing 110 of the gasbag 100 is greater than a curvature of the curved cover plate 300 to be laminated, that is, a curvature of the corner portion 1142 of the carrying portion 114 of the elastic housing 110 is greater than the curvature of the curved portion of the curved cover plate 300. In addition, the angle of the corner portion 1142 of the carrying portion 114 of the elastic housing 110 of the gasbag 100 is greater than the maximum angle of the curved portion of the curved cover plate 300. For example, the curved cover plate 300 is a U-shaped cover plate with the angle of the curved portion is 120°, and the angle of the corner portion 1142 is in a range of 130° to 150°.

When the elastic housing 110 includes a plurality of housings, the curvature of the housing gradually increases in a direction from the outside of the elastic housing 110 of the gasbag to the inside of the elastic housing 110 of the gasbag.

For the laminating device according to the first aspect of the present disclosure, since the elastic housing of the gasbag is provided with the first apertures, when the laminating pressure provided by the gasbag to the member to be laminated reaches the first preset pressure, the gas medium in the elastic housing 110 of the gasbag can be released to the outside of the elastic housing 110 of the gasbag through the first apertures of the elastic housing. That is, the first apertures can be used to automatically adjust the laminating pressure provided by the gasbag, and the maximum laminating pressure can be controlled within a preset range to avoid a poor laminating caused by an inaccurate detection and adjustment of the laminating pressure. In addition, due to the first apertures, the gasbag can always have the preset gas pressure therein through the release of the gas medium, which further ensures the laminating yield.

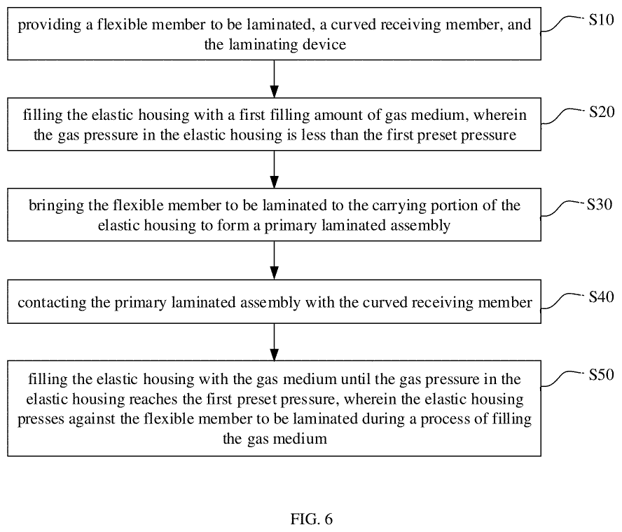

According to a second aspect of the present disclosure, referring to FIG. 6, a laminating method is provided, which can be performed by the laminating device according to any of the above embodiments. The laminating method includes steps of S10 to S50.

S10, providing the flexible member to be laminated, the curved receiving member and the laminating device described in any one of the above embodiments.

S20, filling the elastic housing with a first filling amount of gas medium, wherein the gas pressure in the elastic housing is less than the first preset pressure.

S30, bringing the flexible member to be laminated to the carrying portion of the elastic housing to form a primary laminated assembly.

S40, contacting the primary laminated assembly with the curved receiving member.

S50, filling the elastic housing with the gas medium until the gas pressure in the elastic housing reaches the first preset pressure, wherein the elastic housing presses against the flexible member to be laminated during a process of filling the gas medium.

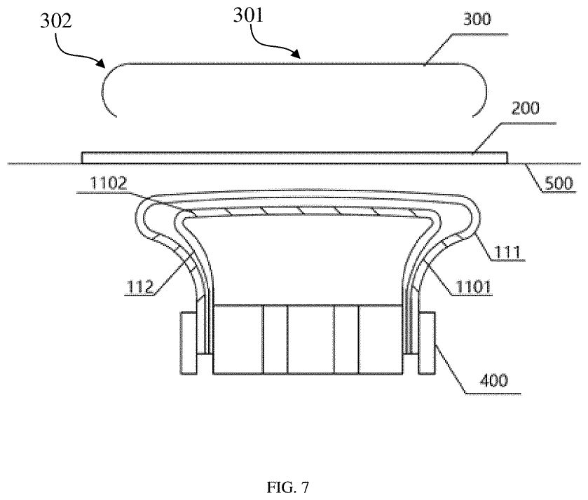

FIG. 7 is a schematic view showing a state before laminating in a laminating method according to an embodiment of the present disclosure. Referring to FIG. 7, the flexible screen 200 and the curved cover plate 300 are taken as an example for illustration. In order to protect the curved cover plate 300, the laminating device further includes a cover plate carrying table to limit and support the curved cover plate 300 during the laminating process.

At S10, the elastic housing 110 is filled with the first filling amount of gas medium, so that the elastic housing 110 can support the flexible screen 200. The gas pressure in the elastic housing is less than the first preset pressure, and the first preset pressure may be the maximum gas pressure required for the laminating process, which can be selected according to actual requirements. In this embodiment, the flexible screen 200 may be assembled with the guiding film 500 firstly, and then disposed in the carrying portion 114 of the elastic housing 110 under dragging of the guiding film 500.

Contacting the primary laminated assembly with the curved receiving member at S40 can be understood that when the alignment process of the flexible screen 200 and the curved cover plate 300 is completed, at least one of the gasbag 100 and the curved cover plate 300 is moved to reduce the distance between the gasbag 100 and the curved cover plate 300, so that the flexible screen 200 enters into the curved cover plate 300 through the gasbag 100, and the laminating process starts. The alignment of the flexible screen 200 and the curved cover plate 300 is not limited to directly setting the aligning points on the flexible screen 200 and the curved cover plate 300, as long as it is ultimately to achieve the purpose of alignment between the flexible screen 200 and the curved cover plate 300.

At S50, the elastic housing 110 is filled with the gas medium until the gas pressure in the elastic housing 110 reaches the first preset pressure, and the elastic housing 110 presses against the flexible member to be laminated during the process of filling gas medium. It can be understood that, in order to facilitate the laminating process, a small amount of gas medium is filled into the elastic housing 110 at first, then the flexible screen 200 can be carried, and the flexible screen 200 can enter into the curved cover plate 300. After the primary laminated assembly is in contact with the curved receiving member, the gas medium can be continuously filled into the elastic housing 110. In this case, the flexible screen 200 which is in contact with the curved cover plate 300 will be gradually laminated to the curved cover plate 300 under the pressure provided by the gasbag 100. As the gas medium in the elastic housing 110 increases, the gas pressure in the elastic housing 110 gradually increases until the first preset pressure is reached.

In addition, when the first preset pressure is reached, the elastic housing 110 can be continuously filled with the gas medium. That is, when the laminating process of the flexible screen 200 and the curved cover plate 300 is completed, a function of the first preset pressure is continued to be kept, which can avoid the generation of bubbles due to insufficient pressure when the laminating process is completed. In addition, due to the first apertures 1101, the gasbag 100 can always have the preset gas pressure therein through the release of the gas medium, which further ensures the laminating yield.

Further, the curved receiving member includes a flat receiving portion and a curved receiving portion. Specifically, the curved cover plate 300 includes a flat portion 301 and a curved portion 302. The step S50 can be specifically: filling the elastic housing 110 with the gas medium, wherein the elastic housing 110 presses against the flexible member to be laminated, the flexible member to be laminated and the curved receiving member are laminated along a direction from the flat receiving portion to the curved receiving portion, such that the flexible member to be laminated and the curved receiving member are gradually laminated together. That is, in this embodiment, the laminating sequence from the flat receiving portion to the curved receiving portion is adopted to avoid the generation of bubbles during the laminating process, which improves the laminating yield.

The laminating method according to the second aspect of the present disclosure is performed by the laminating device according to the first aspect, so that under the first preset pressure, the gas medium in the elastic housing can be released to the outside of the elastic housing through the first aperture, thereby automatically adjusting the laminating pressure and controlling the maximum laminating pressure within the preset range, thereby avoiding a poor laminating caused by an inaccurate detection and adjustment of the laminating pressure.

According to a third aspect of the present disclosure, a display device is provided, which is manufactured by using the laminating device according to any one of the above-mentioned first aspects, or manufactured by using the laminating method according to any one of the above-mentioned second aspects, which can also achieve the automatic and precise adjustment of the laminating pressure, thereby improving the laminating yield.

It can be understood that the foregoing embodiments are specific examples for implementing the present disclosure, and in actual applications, various changes can be made to them in form and details without departing from the spirit and scope of the present disclosure.

What is claimed is:

1. A laminating device configured to laminate a flexible member to be laminated and a curved receiving member comprising:
a gasbag;
wherein the gasbag comprises an elastic housing configured for receiving a gas medium;
wherein the elastic housing comprises a carrying portion and a clamping portion which are connected to each other;
wherein the carrying portion is configured to carry the flexible member to be laminated; and
wherein the elastic housing is provided with a plurality of first apertures; when a gas pressure in the elastic housing reaches a first preset pressure, the gas medium is released to outside of the elastic housing through the first apertures.

2. The laminating device according to claim 1, wherein the first apertures are located in the clamping portion.

3. The laminating device according to claim 1, wherein the elastic housing comprises a first housing and a second housing, wherein the first housing is located on a peripheral side of the second housing;
wherein the elastic housing comprises a first receiving cavity and a second receiving cavity, the first receiving cavity is enclosed by the first housing and the second housing, and the second receiving cavity is defined by the second housing;
wherein the first housing comprises a first clamping portion and the first apertures, the clamping portion comprises the first clamping portion, the first apertures are located in the first clamping portion and;
wherein the second housing comprises at least one second aperture; when the gas pressure in the second housing reaches a second preset pressure, the gas medium in the second housing is released to the first receiving cavity through the at least one second aperture; and the second preset pressure is less than the first preset pressure.

4. The laminating device according to claim 3, wherein the elastic housing further comprises a third housing; wherein the third housing is located between the first housing and the second housing, and the third housing surrounds the second housing;
wherein the first receiving cavity comprises a first sub-cavity and a second sub-cavity; the first sub-cavity is enclosed by the first housing and the third housing; and
wherein the third housing comprises at least one third aperture; when a gas pressure in the third housing reaches a third preset pressure, the gas medium in the third housing is released to the first sub-cavity through the at least one third aperture; and where the third preset pressure is between the first preset pressure and the second preset pressure.

5. The laminating device according to claim 3, wherein the second housing comprises a second clamping portion corresponding to the first clamping portion and the third housing comprises a third clamping portion corresponding to the first clamping portion;
wherein the first clamping portion, the second clamping portion and the third clamping portion are assembled together and arranged side by side; wherein an end surface of the first clamping portion an end surface of the second clamping portion and an end surface of the third clamping portion are located on a same plane.

6. The laminating device according to claim 3, further comprising a gas pressure controlling mechanism in communication with the second receiving cavity, wherein the gas pressure controlling mechanism comprises a gas inlet channel configured for controlling the gas pressure in the elastic housing.

7. The laminating device according to claim 4, wherein the first preset pressure is in a range of 300 Kgf to 350 Kgf; the third preset pressure is in a range of 200 Kgf to 250 Kgf; the second preset pressure is in a range of 100 Kgf to 200 Kgf.

8. The laminating device according to claim 1, wherein a hardness of the carrying portion is less than a hardness of the clamping portion.

9. The laminating device according to claim 8, wherein the carrying portion comprises a body portion and a corner portion which are connected to each other;
wherein the corner portion is located between the body portion and the clamping portion; and
wherein a hardness of the corner portion is less than a hardness of the body portion.

10. A laminating method, comprising:
S10, providing a flexible member to be laminated, a curved receiving member and the laminating device according to claim 1;
S20, filling the elastic housing with a first filling amount of gas medium, wherein the gas pressure in the elastic housing is less than the first preset pressure;
S30, bringing the flexible member to be laminated to the carrying portion of the elastic housing to form a primary laminated assembly;
S40, contacting the primary laminated assembly with the curved receiving member; and
S50, filling the elastic housing with the gas medium until the gas pressure in the elastic housing reaches the first preset pressure, wherein the elastic housing presses against the flexible member to be laminated during a process of filling the gas medium.

11. The laminating method according to claim 10, wherein the curved receiving member comprises a flat receiving portion and a curved receiving portion;
wherein the S50 comprises:
filling the elastic housing with the gas medium; and
wherein the elastic housing presses against the flexible member to be laminated, the flexible member to be laminated and the curved receiving member are laminated along a direction from the flat receiving portion to the curved receiving portion, such that the flexible member to be laminated and the curved receiving member are gradually laminated together.

12. A display device, wherein the display device is manufactured by using the laminating device according to claim 1, or manufactured by using the laminating method according to claim 10.
